(19) United States
(12) Patent Application Publication
(10) Pub. No.: US 2005/0011300 A1
(43) Pub. Date: Jan. 20, 2005

(54) Thumb throttle extender

(75) Inventor: George D. Gates, South Jordan, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: All Rite Products, Inc.

(21) Appl. No.: 10/910,227

(22) Filed: Aug. 2, 2004

Related U.S. Application Data
(63) Continuation-in-part of application No. 29/186,465, filed on Jul. 16, 2003, now Pat. No. D499052.

(51) Int. Cl. G05G 11/00

(52) U.S. Cl. 74/544

(57) ABSTRACT

An extender for a thumb throttle of a vehicle includes an attachment section attachable to the throttle of the vehicle. An extension section extends from the attachment section and is configured to extend beyond an end of the thumb throttle. The attachment section has at least two channels formed in an outer face thereof, the two channels extending across the attachment section from a first side of the outer face to a second side of the outer face. The two channels are configured to each receive at least a portion of a securing device therein to securely attach the extender to the throttle.

This application is a continuation-in-part of U.S. Design patent application Ser. No. 29/186,465, filed Jul. 16, 2003, which is incorporated herein by reference.

### BACKGROUND OF THE INVENTION

1. Field of the Invention

The present invention relates generally to systems for modifying throttles of vehicles. More particularly, the present invention relates to systems for modifying thumb or finger throttles of vehicles.

2. Related Art

Many powered vehicles, such as snowmobiles, all-terrain vehicles (“ATVs”), watercraft, etc., utilize finger or thumb throttles (“thumb throttles”) which enable a rider to adjust the speed of the engine of the vehicle. As opposed to twist throttles, which generally require a rider to twist the throttle about an axis parallel to the handlebars of the vehicle, thumb throttles are generally pivoted about an axis perpendicular to the handlebars. Thus, a rider generally maintains the position of his or her hand on the handlebars of the vehicle while operating the thumb throttle with his or her thumb to increase or decrease the speed at which the vehicle's engine is running.

While thumb throttles are relatively simple to operate, it is well known that the size and strength of riders' hands and thumbs vary widely; from the relatively small hands of children to the relatively large hands of adult male riders. Thus, it is not surprising that many thumb throttles are not optimally configured for all riders, as most manufacturers attempt to provide thumb throttles that fit a majority of “normal” riders, with those riders having smaller or larger hands having to compensate accordingly. Thus, many riders to date have had to cope with thumb throttles of inconvenient size and configuration, resulting in unnecessarily uncomfortable riding experiences. In addition, due to the sometimes ergonomically incorrect configuration of thumb throttles in general, even when a riders' hand is sized to properly operate a thumb throttle, the rider can suffer from thumb or finger fatigue from operating the thumb throttle for extended periods of time.

To address these and other problems related to conventional thumb throttles, devices have been developed that extend or otherwise modify existing thumb throttles to better suit riders. Such devices include throttle extenders which are coupled over vehicle thumb throttles and extend outwardly therefrom to provide an extended area of engagement by a rider. Other such devices include gloves designed to provide an interface between a rider's hand and the thumb throttle of the snowmobile.

While such devices have been somewhat successful, they have proved problematic as well. For example, conventional thumb throttle extenders are not adjustable, and thus suffer the same problem as conventional thumb throttles in that they are not suited to be comfortably operated by a range of sizes of rider's hands. In addition, such devices have proven overly difficult to install and uninstall, often requiring specialized tools that may not be available to riders when in the field, preventing the riders from installing, adjusting or removing the extenders while enjoying an outing.

### SUMMARY OF THE INVENTION

It has been recognized that it would be advantageous to develop a thumb throttle extender that can extend a length of a thumb throttle and that can be adjusted for optimal comfort of a rider. In addition, it has been recognized that it would be advantageous to develop a thumb throttle extender that can be quickly and easily installed on, and removed from, a thumb throttle with little or no specialized tools being required.

The invention provides an extender for a thumb throttle of a vehicle, including an attachment section attachable to the throttle of the vehicle. An extension section can extend from the attachment section and can be configured to extend beyond an end of the thumb throttle. The attachment section can have at least two channels formed in an outer face thereof. The two channels can extend across the attachment section from a first side of the outer face to a second side of the outer face. The two channels can be configured to each receive at least a portion of a securing device therein to securely attach the extender to the throttle.

In accordance with another aspect of the invention, a reconfigurable extender for a thumb throttle of a vehicle is provided, including an inner stiffener and an outer casing. The outer casing can be disposed at least partially about the inner stiffener and can extend along a longitudinal axis of the inner stiffener. The outer casing can be engageable by a hand of a rider of the vehicle. The inner stiffener and the outer casing can be cooperatively reconfigurable to allow an extension section of the extender to be adjusted relative to the throttle.

In accordance with another aspect of the invention, a reconfigurable extender for a thumb throttle of a vehicle is provided, including an attachment section attachable to the throttle of the vehicle and an extension section extending from the attachment section. The extension section can have a first configuration in which the extension forms a first angle with respect to the attachment section and a second configuration, in which the extension section forms a second angle with respect to the attachment section, different from the first angle.

In accordance with another aspect of the invention, a method of extending a thumb throttle of a vehicle is provided, including the steps of: disposing an attachment section of an extender adjacent to the throttle of the vehicle with an extension section extending beyond an end of the throttle; and cinching at least two securing devices around the attachment section of the extender and the throttle, with the securing devices extending within at least two channels formed in an outer face of the attachment section.

In accordance with another aspect of the invention, a method of modifying a nominal angle of a thumb throttle of a vehicle is provided, including the steps of: disposing an attachment section of an extender adjacent to the thumb throttle of the vehicle; securing the attachment section of the extender to the thumb throttle; and bending the extender to modify an angle between the attachment section and an extension section of the extender.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a thumb throttle extender attached to a throttle of a vehicle in accordance with an embodiment of the present invention;

FIG. 2 is a perspective view of the thumb throttle of FIG. 1 removed from the vehicle;

FIG. 3A is an end view of the thumb throttle extender of FIGS. 1 and 2 taken from the right end of the extender as shown;

FIG. 3B is an end view of the thumb throttle extender of FIGS. 1 and 2 taken from the left end of the extender as shown;

FIG. 4 is a rear, partially sectioned view of a throttle extender in accordance with another embodiment of the present invention;

FIG. 5A is a top view of the extender of FIG. 4; and

FIG. 5B is a top view of the extender of FIG. 5A in a reconfigured, angled configuration.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

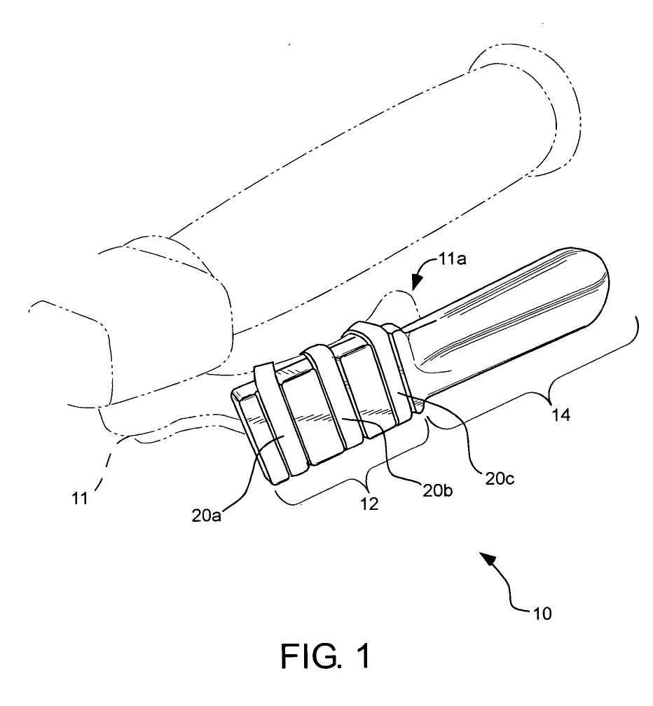

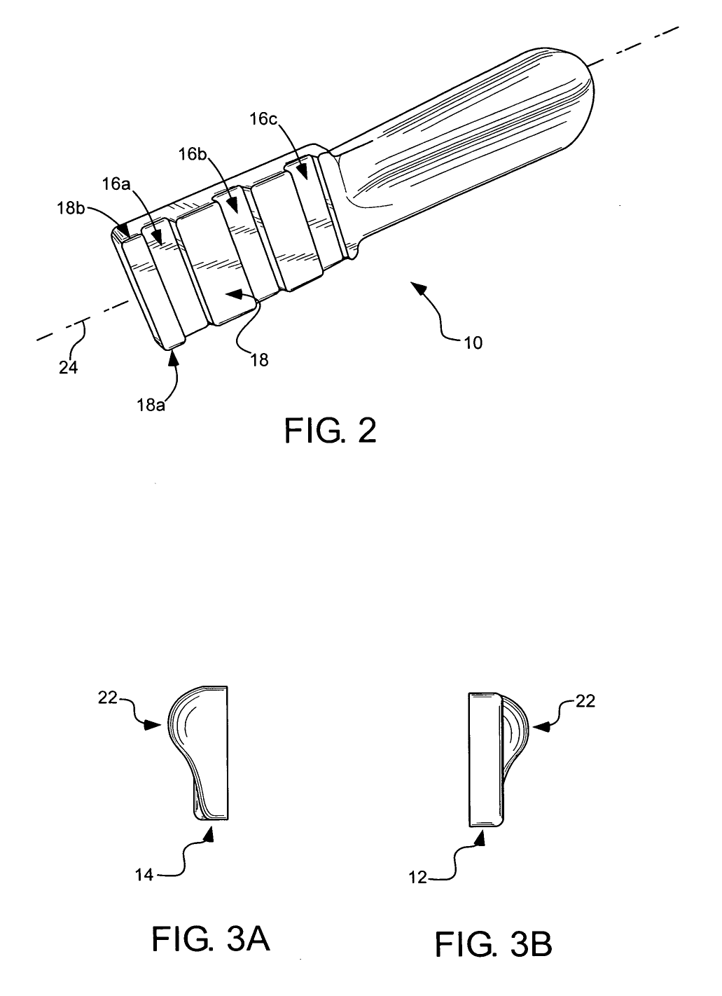

Illustrated in FIGS. 1 and 2 in accordance with one aspect of the present invention is an extender 10 for a thumb throttle 11 of a vehicle. The extender can include an attachment section 12, which can be attachable to the throttle, and an extension section 14. The extension section can extend from the attachment section of the extender, and can be configured to extend beyond an end 11a of the thumb throttle. As best seen in FIG. 2, the attachment section can include at least two channels 16a, 16b formed in an outer face 18 thereof. The two channels can extend across the attachment section from a first side 18a of the outer face to a second side 18b of the outer face. The two channels can be configured to each receive at least a portion of a securing device 20a, 20b (FIG. 1), respectively, therein to securely attach the extender to the throttle.

The extender 10 can advantageously be quickly attached to and/or removed from the thumb throttle by placing the attachment section 12 of the extender adjacent the throttle 11 and engaging securing devices 20a, 20b in or through channels 16a, 16b, respectively. The securing devices can then be cinched about the throttle to secure the extender to the throttle. The securing devices can be of a number of types known to those in the art, including securable straps such as nylon straps, etc. In one aspect of the invention the securing devices comprise self-locking nylon “cable” ties which include a small one-way restraining head (not shown) that allows the looped body of the tie to be cinched in one direction yet restrains the body from traveling back through the head in the other direction.

The securing devices and receiving channels advantageously allow the extender to be attached to the throttle very quickly and without specialized tools. In addition, the securing devices can be easily removed by cutting the nylon ties with a pair of pliers or a small pocketknife. In this manner, if it is desired to remove the extender while in the field, it is not necessary to have access to specialized tools, such as wrenches or screwdrivers. Thus, as many vehicle riders carry some type of pocketknife or penknife, most riders can attach and/or remove the extender with equipment typically carried while riding. As the securing devices 20a, 20b extend within the receiving channels 16a, 16b, respectively, lateral or longitudinal motion of the securing devices relative to the extender is limited, preventing the securing devices from sliding off the end of the extender, which can result in the extender becoming disengaged from the throttle.

The receiving channels 16a, 16b can be formed in the outer face 18 such that the securing devices 20a, 20b are recessed below, or flush with, an outer surface of the outer face when cinched about the attachment section 12. In this manner, the securing devices do not interfere with a rider's hand when operating the thumb throttle 11. In addition, by disposing the securing devices below or flush with the surface of the outer face, the rider's hand is not pinched or cut when operating the thumb throttle.

As best appreciated in end view in FIGS. 3A and 3B, with FIG. 3A taken from the right side of FIG. 2 and FIG. 3B taken from the left side of FIG. 2, in one aspect of the invention the extension section 14 includes an elongate bulbous portion or shape 22 protruding outwardly therefrom. The elongate bulbous shape can be configured to provide an interface between a hand of a rider of the vehicle and the extender. By forming the elongate bulbous shape on the extension section, a rider can more easily engage the extension section with his or her hand, for example, in his or her palm, which advantageously allows the rider to operate the throttle with less fatigue than if a thumb or finger is used.

Returning to FIG. 2, the receiving channels 16a, 16b and 16c can be formed in the outer face 18 of the extender to be substantially parallel to each other and to be substantially orthogonal to a longitudinal axis 24 of the attachment section. In this manner, the attachment section can be securely attached to the throttle across a large portion of the throttle to maximize the interface area between the extender and the throttle. While not so limited, in this aspect of the invention the extender can include at least three substantially parallel channels formed in the outer face of the attachment section.

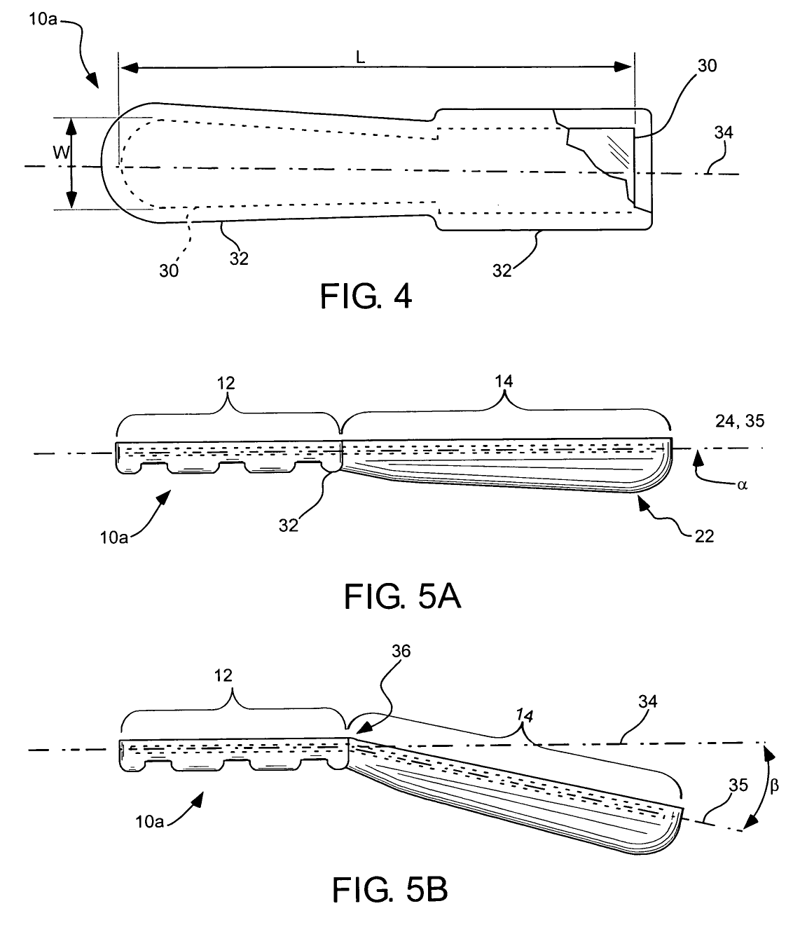

Turning now to FIGS. 4 and 5A, an alternate embodiment of the invention is shown, wherein reconfigurable extender 10a can include an inner stiffener 30 and an outer casing 32. The outer casing can be disposed at least partially about the inner stiffener and can extend along a longitudinal axis 34 of the inner stiffener. The outer casing can be engageable by a hand (not shown) of a rider of the vehicle to allow the rider to manipulate the extender, and thus the throttle (11 in FIG. 1) of the vehicle. In one aspect of the invention, the inner stiffener and the outer casing can be cooperatively reconfigurable to allow the extension section 14 of the extender to be adjusted relative to the throttle.

The inner stiffener 30 can be formed from a variety of materials and can be configured in a variety of shapes and sizes. In one aspect of the invention, at least a portion 36 (FIG. 5B) of the inner stiffener can be inelastically pliable to provide a bendable portion to the stiffener about which the stiffener can be inelastically bent into a different angular configuration. As shown in FIG. 5A, in one aspect of the invention the extender 10a can include a first configuration in which the extension section 14 forms a first angle α with respect to the attachment section 12 (in the example shown in FIG. 5A the first angle α is substantially zero, with the longitudinal axis 24 of the attachment section of the extender being substantially parallel with an axis 35 of the extension section of the extender).

As shown in FIG. 5B, the extender can include a second configuration, in which the extension section 14 forms a second angle β with respect to the attachment section 12. In this aspect the second angle is different from the first angle, with the longitudinal axis 24 of the attachment section forming an acute angle with the longitudinal axis 35 of the extension section 14. While in the examples shown in FIGS. 5A and 5B the first and second angles are zero and some arbitrary acute value, respectively, it is to be understood that the first and second angles can each vary through a variety of angles. For example, the first angle, which may be the angle at which the extender is configured when sold to consumers, may be offset from zero and the second angle may be further or less offset from zero with respect to the first angle.

Examples of suitable materials from which the inner stiffener can be formed include relatively ductile metals such as aluminum, steel, alloys, etc. In the aspects of the invention in which the extender is reconfigurable, selection of a suitable material will depend upon the ability of the material to be both i) bent, or reconfigured, by a user into a desired operating position; and ii) to retain itself in the bent or reconfigured position when pushed or pulled by the user to operate the throttle. It will be appreciated that if the inner stiffener is formed from an overly soft material, the inner stiffener may simply deform under application of pressure to the extender by the riders' thumb, and only partially activate the throttle in response to the pressure. Similarly, if the inner stiffener is formed from a material that is not sufficiently ductile, the stiffener may not be easily bent by a rider, and/or may fracture when the rider attempts to bend the stiffener.

The inventors have found that one suitable material for the inner stiffener is 304 Stainless Steel. Such a material has been found to have a Young's Modulus on the order of 200 GPa. In one aspect of the invention, the inner stiffener includes a thickness (into the plane of the page of FIG. 4) on the order of 0.062 inches, a maximum length L of 4.25 inches and a maximum width W of 0.75 inches. Such a material in the given configuration has proven sufficiently ductile so as to allow relatively easy reconfiguration of the extender into a new configuration; while remaining sufficiently stiff in the new configuration to avoid deforming under pressure applied by the rider to activate the throttle.

As shown by example in FIG. 4, in one aspect of the invention the outer casing 32 can extend around substantially all of the inner stiffener 20 to substantially encase the inner stiffener. While not so required, such a relationship allows the relatively soft outer casing to provide a protective cover over the stiffener to cover any sharp edges of the inner stiffener which might cut or scrape an operator's hand. In this and other aspects of the invention it is desirable that the outer casing be more flexible than the inner stiffener to provide a cushioning interface between the rider's hand and the outer casing while allowing the inner stiffener to add strength to the extender. In other aspects of the invention, the outer casing can extend only partially around or along the inner stiffener.

In addition to the structural aspects described above, the present invention also provides a method of extending a thumb throttle of a vehicle, including the steps of: disposing an attachment section of an extender adjacent to the throttle of the vehicle with an extension section extending beyond an end of the throttle; and cinching at least two securing devices around the attachment section of the extender and the throttle, with the securing devices extending within at least two channels formed in an outer face of the attachment section.

In accordance with another aspect of the invention, a method of modifying a nominal angle of a thumb throttle of a vehicle is provided, including the steps of: disposing an attachment section of an extender adjacent to the thumb throttle of the vehicle; securing the attachment section of the extender to the thumb throttle; and bending the extender to modify an angle between the attachment section and an extension section of the extender.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. An extender for a thumb throttle of a vehicle, comprising:
an attachment section attachable to the throttle of the vehicle; and
an extension section extending from the attachment section and being configured to extend beyond an end of the thumb throttle;
the attachment section having:
at least two channels, formed in an outer face thereof, the two channels extending across the attachment section from a first side of the outer face to a second side of the outer face, the two channels being configured to each receive at least a portion of a securing device therein to securely attach the extender to the throttle.

2. The extender of claim 1, further comprising a pair of securable straps, extendable within the channels and being configured to extend around the attachment section and the thumb throttle to secure the attachment section to the thumb throttle of the vehicle.

3. The extender of claim 1, wherein the extension section includes an elongate bulbous shape protruding outwardly therefrom, the elongate bulbous shape being configured to provide an interface between a hand of a rider of the vehicle and the extender.

4. The extender of claim 1, wherein the channels are substantially parallel to each other and are each substantially orthogonal to a longitudinal axis of the attachment section.

5. The extender of claim 4, further comprising at least three substantially parallel channels formed in the outer face of the attachment section.

6. The extender of claim 1, further comprising:
an inner stiffener; and
an outer casing, disposed at least partially about the inner stiffener, the outer casing extending along a longitudinal axis of the inner stiffener and being engageable by a hand of a rider of the vehicle.

7. The extender of claim 1, wherein the extender is reconfigurable to allow the extension section of the extender to be adjusted relative to the thumb throttle.

8. The extender of claim 1, wherein the channels extend laterally across the attachment section.

9. The extender of claim 1, wherein at least one of the attachment section and the extension section is bendable.

10. A reconfigurable extender for a thumb throttle of a vehicle, comprising:
an inner stiffener; and
an outer casing, disposed at least partially about the inner stiffener, the outer casing extending along a longitudinal axis of the inner stiffener and being engageable by a hand of a rider of the vehicle;
the inner stiffener and the outer casing being cooperatively reconfigurable to allow an extension section of the extender to be adjusted relative to the throttle.

11. The extender of claim 10, wherein at least a portion of the inner stiffener is inelastically pliable to provide a bendable portion to the stiffener about which the stiffener can be inelastically bent into a different angular configuration.

12. The extender of claim 10, wherein the outer casing extends around substantially all of the inner stiffener.

13. The extender of claim 10, wherein the outer casing is more flexible than the inner stiffener.

14. The extender of claim 10, further comprising:
an attachment section attachable to the throttle of the vehicle, the attachment section having:
at least two channels formed in an outer face thereof, the at least two channels extending across the attachment section from a first side of the attachment section to a second side of the attachment section, the two channels being configured to each receive a securing device therein to securely attach the extender to the throttle.

15. The extender of claim 14, wherein the extension section includes an elongate bulbous portion protruding outwardly therefrom, the bulbous portion being configured to provide an interface between a hand of a rider of the vehicle and the extender.

16. The extender of claim 14, wherein the channels are substantially parallel to each other and are each substantially orthogonal to a longitudinal axis of the attachment section.

17. The extender of claim 16, further comprising at least three substantially parallel channels formed in the outer face of the attachment section.

18. The extender of claim 14, further comprising a pair of securable straps, engageable within the channels and being configured to secure the attachment section to the thumb throttle of the vehicle.

19. A reconfigurable extender for a thumb throttle of a vehicle, comprising:
an attachment section attachable to the throttle of the vehicle; and
an extension section extending from the attachment section, the extension section having:
i) a first configuration in which the extension forms a first angle with respect to the attachment section; and
ii) a second configuration, in which the extension section forms a second angle with respect to the attachment section, different from the first angle.

20. The extender of claim 19 wherein the first angle is substantially zero.

21. The extender of claim 19, wherein the attachment section includes at least two channels formed in an outer face thereof, the two channels extending across the attachment section from a first side of the outer face to a second side of the outer face, the two channels being configured to each receive at least a portion of a securing device therein to securely attach the extender to the throttle.

22. A method of extending a thumb throttle of a vehicle, comprising the steps of:
disposing an attachment section of an extender adjacent to the throttle of the vehicle with an extension section extending beyond an end of the throttle; and
cinching at least two securing devices around the attachment section of the extender and the throttle, with the securing devices extending within at least two channels formed in an outer face of the attachment section.

23. The method of claim 22, comprising the further step of reconfiguring the extender by inelastically bending a portion of the extender such that the extender forms an angle relative to the throttle different from an original angle formed between the extender and the throttle.

24. A method of modifying a nominal angle of a thumb throttle of a vehicle, comprising the steps of:
disposing an attachment section of an extender adjacent to the thumb throttle of the vehicle;
securing the attachment section of the extender to the thumb throttle; and
bending the extender to modify an angle between the attachment section and an extension section of the extender.

25. The method of claim 24, wherein the step of securing the attachment section of the extender to the thumb throttle includes the step of cinching each of pair of securable straps through i) a pair of channels formed in the extender; and ii) around the thumb throttle.
